(19) United States
(12) Patent Application Publication
(10) Pub. No.: US 2005/0217132 A1
(43) Pub. Date: Oct. 6, 2005

(54) Moisture absorber

(76) Inventors: Robert C. Ashford, Bethlehem, PA (US); Daniel E. Lewis, Macungie, PA (US)

Correspondence Address: SCHACHT LAW OFFICE, INC., SUITE 202, 2801 MERIDIAN STREET, BELLINGHAM, WA, 98225-2412, US

(21) Appl. No.: 11/078,871

(22) Filed: Mar. 9, 2005

Related U.S. Application Data
(60) Provisional application No. 60/551,859, filed on Mar. 10, 2004.

(51) Int. Cl. F26B 21/06

(52) U.S. Cl. 34/81

(57) ABSTRACT

A container for a combination moisture absorber and deodorizer is constructed from an upper half and a lower half that, when joined together, define an enclosed interior. The upper half has a plurality of openings that allow ambient air to pass from outside the container to the enclosed interior. A tray is seated above a collection surface on the lower half and is provided with a plurality of openings that allow moisture absorbed from the air to pass from the tray to the collection surface. A moisture absorbing medium that is preferably dissolvable is preferably provided on the tray for transforming moisture from the air into liquid that passes through the tray and collects on the collection surface. A deodorizing medium is also preferably provided on either the tray or the collection surface (or both) for adding a deodorizing effect.

This application claims the benefit of U.S. Provisional Application Ser. No. 60/551,859, filed Mar. 10, 2004, which is incorporated by reference herein in its entirety.

### FIELD OF INVENTION

The present invention relates to a moisture absorber generally, and more particularly to a container for a moisture absorber and a deodorizer.

### BACKGROUND OF THE INVENTION

Atmospheric water vapor is problematic in many situations. This is particularly so in situations combining high humidity with close or closed environments such as crowded rooms or closets. Some of the problems high humidity can cause are caking of dried powder and granular substances, increase growth of mildew and fungi, corrosion of metal surfaces, and water contamination of organic liquids (especially internal combustion engine fuels). A variety of solutions have evolved or been developed in the field to address these problem situations.

U.S. Pat. No. 5,907,908 to Cunanan et al. discloses a disposable dehumidifying and deodorizing pouch having a moisture-absorption section and a moisture collection section. The pouch is a disposable, self-contained unit that is adapted to be hung from a closet rod and disposed of after it becomes saturated with moisture.

U.S. Pat. No. 5,148,613 to Cullen discloses a closet drier in a bucket conformation, having upper and lower compartments and an open top covered with a gas permeable membrane. The Cullen device is an open container and must be placed on the floor or some other surface.

### SUMMARY OF THE INVENTION

A container for a combination moisture absorber and deodorizer comprises an upper half and a lower half that, when joined together, define an enclosed interior. The upper half further comprises a plurality of openings that allow ambient air to pass from outside the container to the enclosed interior. A tray is seated above a collection surface on the lower half of the container and is provided with a plurality of openings that allow moisture absorbed from the air to pass from the tray to the collection surface. A moisture absorbing medium that is preferably dissolvable is preferably provided on the tray for transforming moisture from the air into liquid that passes through the tray and collects on the collection surface. A deodorizing medium is also preferably provided on either the tray or the collection surface (or both) for adding a deodorizing effect.

### BRIEF DESCRIPTION OF THE DRAWINGS

FIG. 1 is a perspective view of the combination moisture absorber and deodorizer of the present invention in the closed position.

FIG. 2 is a front view thereof.

FIG. 3 is a cross-section view taken through the transverse center of the combination moisture absorber and deodorizer.

FIG. 4 is a top view thereof.

FIG. 5 is a perspective view of the combination moisture absorber and deodorizer in the open position.

FIG. 6 illustrates a tray used in the combination moisture absorber and deodorizer of the present invention.

FIG. 7 is an exploded view of the combination moisture absorber and deodorizer in the open position.

FIG. 8 is a partial enlarged section view of the latch mechanism of the invention.

FIG. 9 illustrates an inventive hook used with the combination moisture absorber and deodorizer of the invention.

FIG. 10 is a partial view of a top section of the combination moisture absorber and deodorizer of the invention for purposes of illustrating use of the hook of the invention.

### DETAILED DESCRIPTION OF THE INVENTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

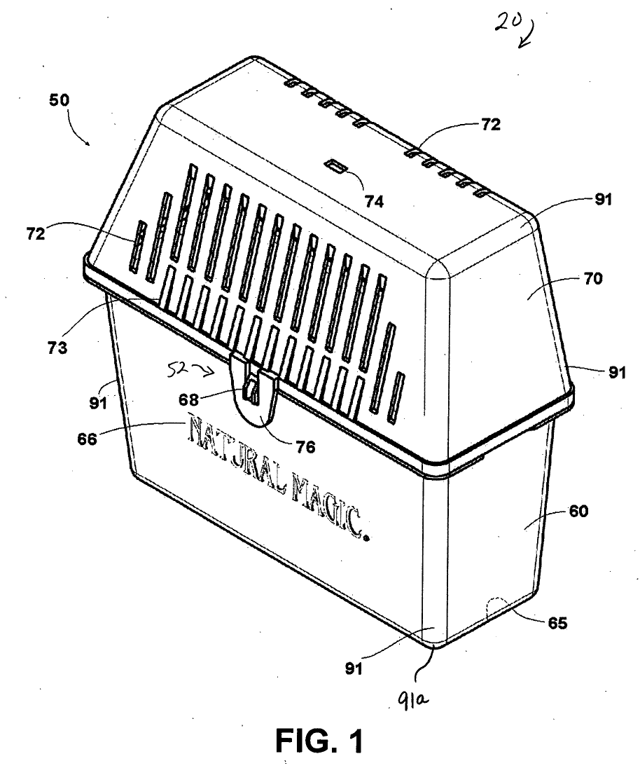

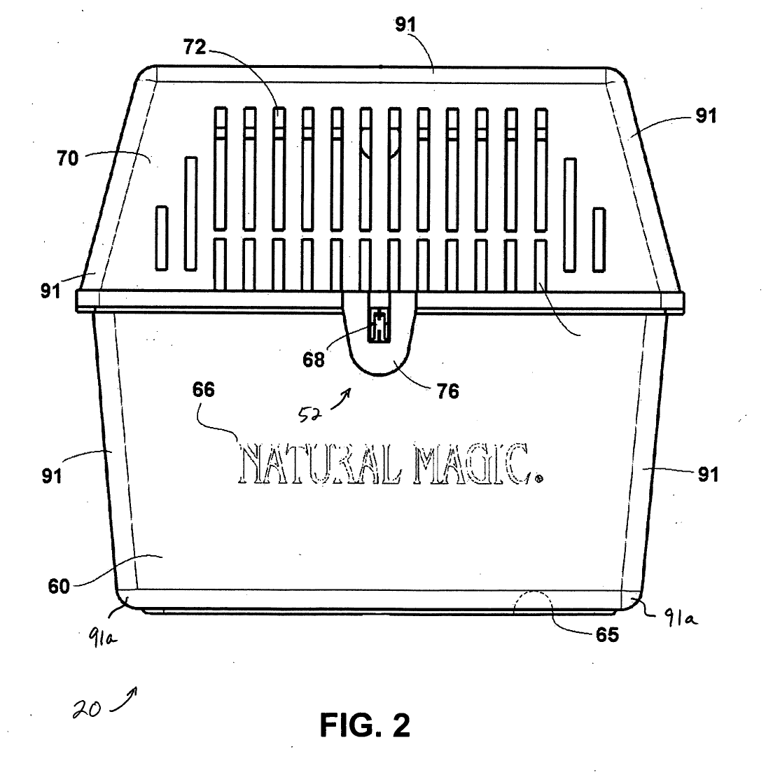

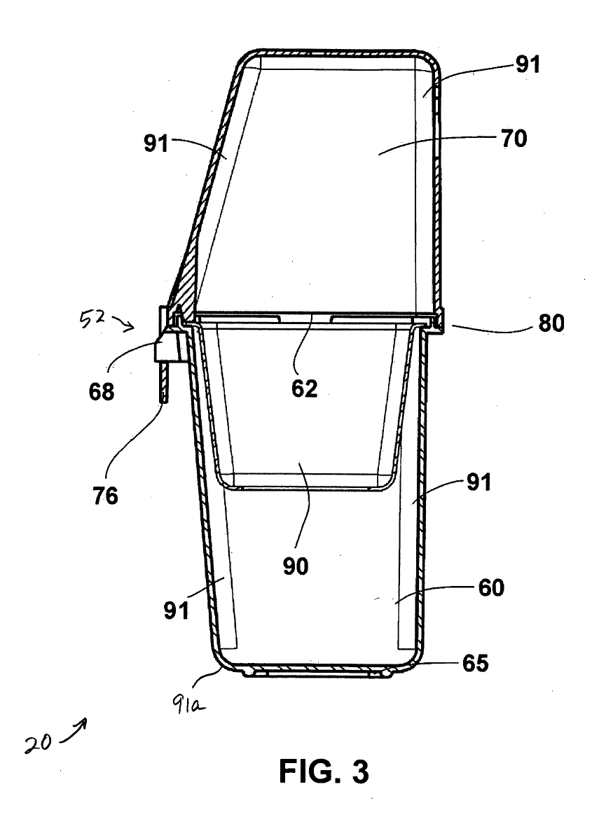

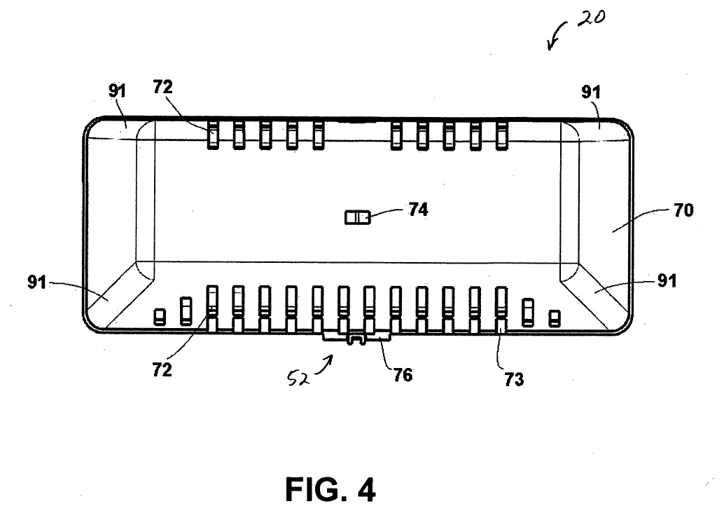

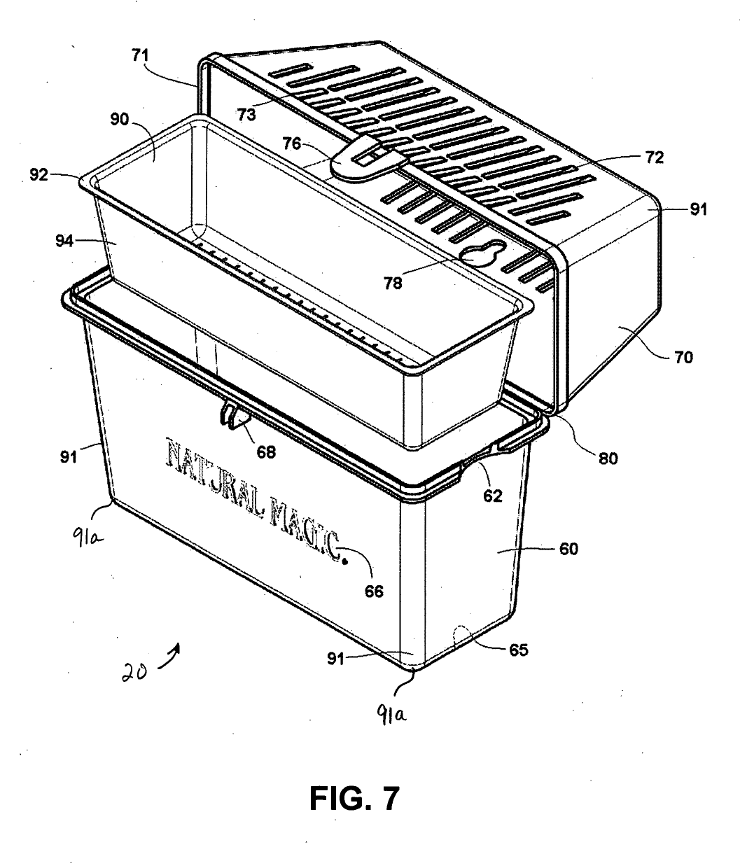

Depicted at 20 in FIGS. 1-5 and 7 of the drawing is a moisture absorbing system 20 constructed in accordance with, and embodying, the principles of the present invention. The example moisture absorbing system 20 comprises a container 50 comprising a lower shell 60 and an upper shell 70. The example lower and upper shells 60 and 70 are connected by a flexible “living hinge” 80. The example moisture absorbing system 20 further comprises a removable plastic tray 90. While the tray is described as being made from plastic, it will be understood that other materials could be used as desired.

The example lower half or shell 60 of the container 50 is preferably comprised of a thin-walled yet sturdy translucent plastic shell with sides tapering downward from a round cornered rectangular opening to a closed, flat, round cornered rectangular bottom. The taper of its rear surface is nearly vertical to allow the container 50 to be positioned against a flat, vertical surface while the other three, tapered sides may incorporate a steeper angle for decorative purposes. The flat surfaces of the lower half 60 may have a sand blasted finish, and its edges 91 and corners 91a may have a smooth or “glass-like” finish. This optional glass-like finish on the edges 91 of the container 50 both allows the user to better see the level of water in a collection area 65 and provides a more decorative appearance.

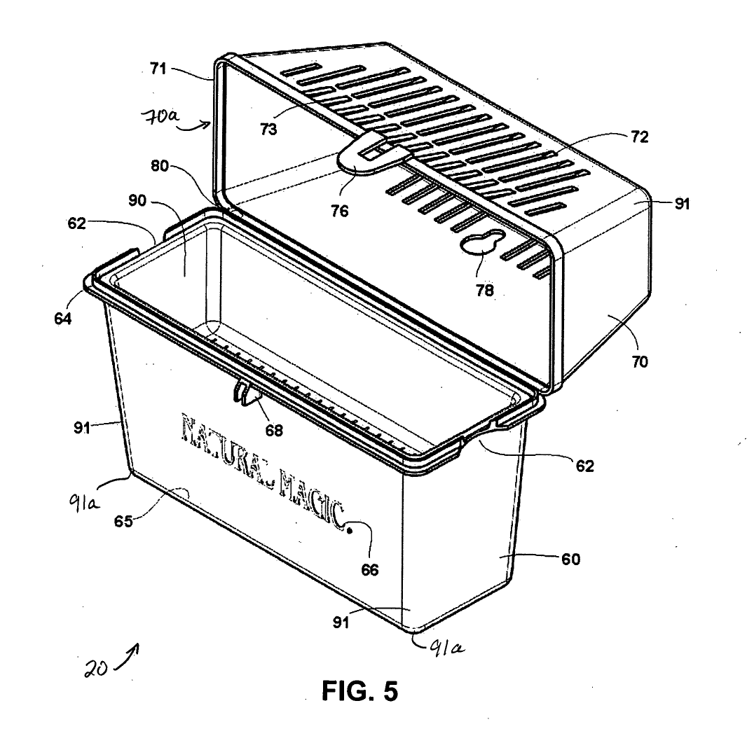

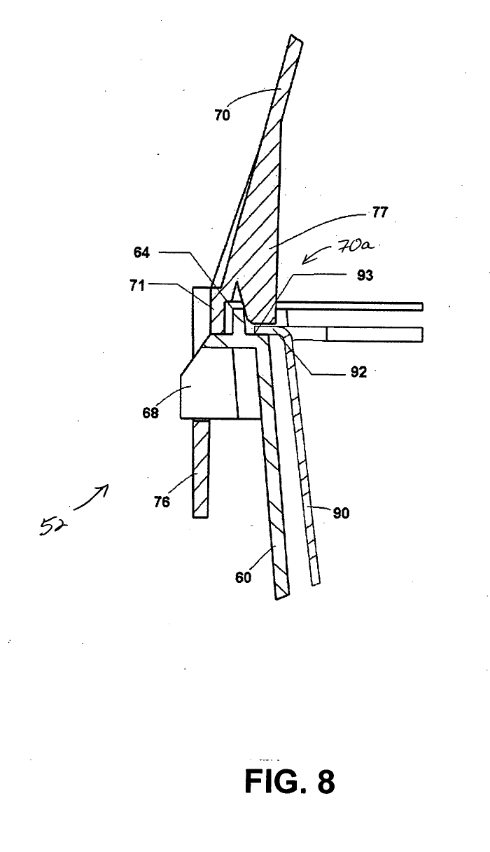

A raised rim 64 around the opening in the lower half 60 forms a closure line that is overlapped by a rim portion 70a (FIGS. 5 and 8) formed in the mating opening of the upper half 70 of the container 50. A hinge 80 is incorporated along the rear edge of the lower half 60 of the container 50 at the closure line which is also formed in the corresponding position of the mating lip 71 of the upper half 70 of the container 50. The example hinge 80 is a flexible “living” hinge of the type commonly used in the plastics industry, but other types of hinges may be employed. Centered on this rim portion 70a, on the frontal surface of the lower half 60 of the container 50, is the “male” portion 68 of a latching mechanism 52 that, by interlocking with the corresponding “female” portion 78 of the latching mechanism 52 molded into the upper half 70 of the container 50, allows the container 50 to be securely closed.

A ledge 93 (FIG. 8) formed into the top edge of the inside wall of the lower half 60 of the container 50 is designed to support a lip 92 which is formed into the top edge of a removable tray 90. This will allow the tray 90 to be suspended above the bottom or floor 65 of the lower half 60 of the container 50, resulting in a collection area for liquid below the tray 90.

The example lower half 60 of the container 50 comprises a semi-circular bead that projects downward from the outer bottom surface of the lower half 60 to permit the container 50 to sit-stably on flat surfaces. A brand name or logo, in raised characters or designs 66, may be molded into the exterior front surface of the lower half 60 of the container 50 as desired by the user.

A portion 62 of the rim 64 at the closure line on both sides of the lower half 60 of the container 50 may be removed to provide “grip points” which will facilitate tray 90 removal. When the container 50 is in the opened position, the user will be able to grasp the lip 92 at both ends of the tray 90 and lift it out of the lower half 60 of the container 50, avoiding contact with any moisture-absorbing material contained within the tray.

The “male” portion 68 of the latching mechanism protrudes from the front surface of the lower half 60 of the container 50 and is incorporated into the center of the rim 64, perpendicular to the closure line. Its shape is preferably rectangular (although other shapes are possible). Optionally, a chamfer added to its upper exterior edge to facilitate the proper engagement of the mating “female” portion 76 of the latching mechanism 52 that is built into the lip 71 at the closure line of the upper half 70 of the container 50. The example upper half 70 of the container 50 is comprised of a sturdy translucent plastic shell with sides tapering upward from a round cornered rectangular opening to a closed, flat, round cornered, rectangular top. The angle of its rear surface is near vertical to allow the container 50 to be positioned against a flat, vertical surface while the other three tapered sides may use a steeper angle for a decorative appearance. The sides of the example upper half 70 may have a sand blasted finish and its edges and its corners 91 may have a smooth or “glass-like” finish. This glass-like finish on the edges of the upper half 70 of the container 50 decoratively matches those of the lower half 60 of the container 50.

The raised lip 71 at the opening of the upper half 70 of the container forms a closure line that overlaps a rim 64 formed into the mating opening of the lower half 60 of the container 50. The hinge 80 connects the upper 70 and lower 60 halves of the container 50 along the rear closure line. The hinge 80 will facilitate repeated opening and closing of the container 50 while maintaining accurate alignment between the two halves 60, 70, thereby ensuring the proper engagement of the latching mechanism 52. The “female” portion 76 of the latching mechanism 52 protrudes from the front surface of the upper half 70 of the container 50 and is incorporated into the center of the lip 71 at the closure line. The female portion 52 may be “U” shaped with a rectangular notch that positively captures the “male” portion 68 of the latching mechanism built into the rim 64 of the lower half 60 of the container 50, allowing the container 50 to be securely closed. This rounded profile provides more comfortable means of disengaging the latch.

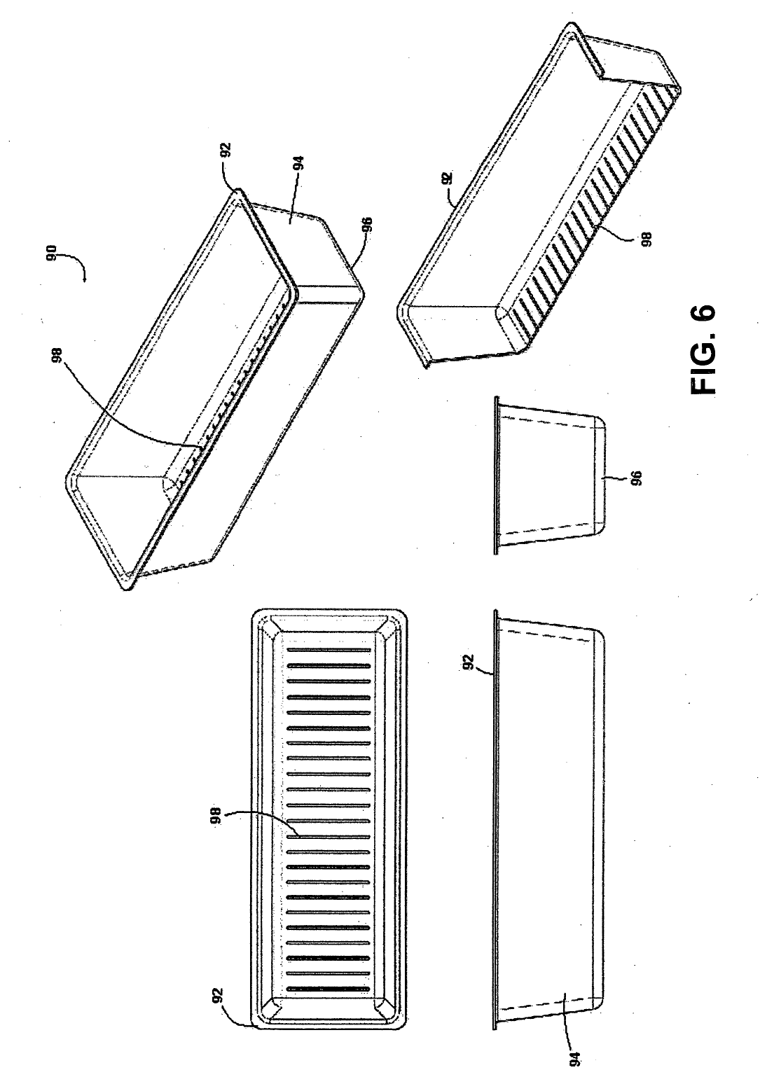

A thin, raised fin 77 (FIG. 6), centered on the inside wall of the upper half of the container 50, extends from below the lower ends of the vertical slotted vents 72 and tapers to a terminus just below the lip 71 at the closure line. When the container 50 is closed, the lower end of this fin will be positioned immediately inside the rim 64 at the closure line of the lower half 60 of the container 50. Its purpose is to reinforce the latching mechanism such that, when closed, the container 50 will resist opening by unintended disengagement should the front wall of the lower half 60 of the container 50 be compressed inward.

Vertical slotted vents 72 are preferably functionally and decoratively positioned on the front and rear surfaces of the upper half 70 of the container to allow proper airflow. Such slots may be positioned in locations on the container 50 other than shown in the drawings. Protruding ridges 73, in vertical alignment with the longer slotted vents 72 on the front surface of the upper half 70 of the container 50, are used to both reinforce the wall in the area of the latch mechanism and to add a decorative appearance.

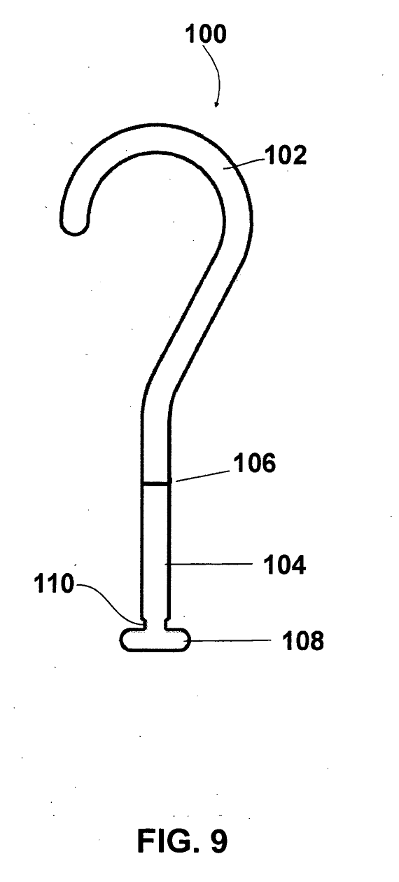

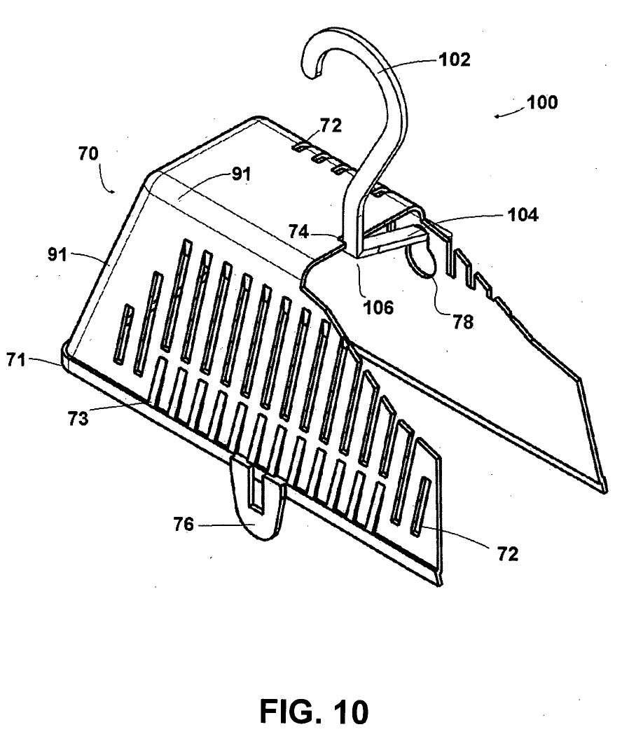

A keyhole-shaped opening 78 located on the rear of the upper half 70 of the container 50 permits mounting on a wall or other flat, vertical surface. This space-saving feature allows for user location of the container 50 beyond the reach of children and pets. This opening 78 can also be used to secure the end of a stem 104 of the optional hanger attachment 100 (FIGS. 9-10). A horizontal, longitudinally-oriented, slot 74 is positioned in the top surface of the upper half 70 of the container 50 to allow for the stem 104 of the hanger 100 to be inserted and connected into the keyhole-shaped slot 78 in the rear surface of the upper half 70 of the container 50. In use, the stem 104 of the hanger attachment 100 is designed to pass vertically downward through the slot 74 in the top of the container, flex toward the rear wall and pass through the keyhole-shaped opening 78. The slot is preferably positioned directly above the approximate center of gravity of the container 50, allowing for a horizontal (level) position when suspended from the hanger attachment 100.

The loose hanger attachment piece 100 supplied with the container 50 is a separate component with the geometric shape preferably shown in the graphic illustration. Its design incorporates an arc-shaped hook 102 and the elongated stem 104 with a “T” shape 108 formed into its end. It may be a molded item or one stamped from flat plastic stock. Other methods of manufacture are contemplated. The stem 104 of the hanger 100 is designed to pass vertically downward through the rectangular slot 74 in the upper half 70 of the container 50, flex toward the back wall and pass through the keyhole-shaped opening 78. Pulling the stem 104 upward will cause slots 110 adjacent to the formed “T” shape 108 in the end of the stem 104 to engage the narrow edges at the top of the keyhole opening 78, forming a snug fit, positively gripping the keyhole opening, securing the end of the hanger stem to the upper half 70 of the container 50.

The flexing of the hook attachment stem is preferably facilitated by a living hinge feature 106 formed in the stem at the bend line where the stem 104 passes through the slot 74 in the upper half 70 of the container 50. When properly installed, the hanger 100 will allow the container 50 to be suspended vertically in a closet or another suitable location. The hook 102 at the end of the hanger is designed to support the weight of the container 50 if filled with both liquid and moisture-absorbing material in the tray. The hanger 100 is preferably provided with the container 50 but its use is optional. The arc-shaped hook 102 incorporated into the top of the hanger 100 is designed to encircle a standard-sized, horizontally-mounted rod found in most household closets. It will also properly engage with other styles of protruding hangers or brackets. The hook provides for a space-saving, right-angle orientation of the container when suspended from a closet rod.

The tray 90 is comprised of a sturdy plastic shell with sides 94 tapering downward from a round cornered, rectangular opening to a flat, round cornered, rectangular bottom. The tapered side surfaces 94 are designed to provide space between the inner walls of the lower half 60 of the container 50 and the outer wall of the tray so that the tray may be installed and removed without interference. The lip 92 at the upper opening is designed to rest upon the ledge 93 formed into the top of the inside wall of the lower half 60 of the container 50. This will allow the tray to be suspended above the bottom of the lower half 60 of the container 50, resulting in the collection area 65 for extracted liquid below the tray.

A series of narrow slots 98 is formed into the bottom 96 of the tray to allow liquid to pass through the tray into the collection area 65 while preventing granular material contained within the tray from passing through. Such slots 98 may be aligned along the transverse axis of the tray 90 as shown, or along the longitudinal axis (not shown). Such slots 98 may also have a different configuration from that shown in the drawings.

During use, the upper half 70 of the container 50 is unlatched and opened and the tray 90 is attached to the bottom half 60 of the container 50 as shown in FIG. 5. Beads or pellets of a moisture-absorbing medium, such as calcium chloride, are then arranged onto the tray 90 and the upper half 70 is then latched closed to the lower half 60. Ambient moisture in the atmosphere enters through the vents 72 and is absorbed by the moisture-absorbing medium arranged on the tray 90. Once the moisture-absorbing medium becomes saturated with moisture, such medium dissolves and excess moisture drips through the slots 98 in the tray 90 and collects on the floor 65 of the bottom half 60 of the container 50. After all of the moisture-absorbing medium has dissolved and excess moisture has collected in the lower half 60 of the container, the container is opened, the tray is removed and the collected moisture is dumped out or drained from the container. Thereafter, the tray is re-seated onto the lower half 60 of the container 50 and the process is repeated.

To obtain a deodorizing effect, deodorizing beads or pellets may be mixed in with the moisture-absorbing medium on the tray, which emit a deodorizer and/or deodorizing scent through the vents 72. Such scent may be a cedar scent, for example, which might be preferred if used in closets for storing clothing and the like. Alternatively, a gelling agent may be provided on the floor 65 of the lower half 60 of the container 50 to soak up the excess moisture that drips through the tray slots 98. Such gelling agent may initially be in the form of a powder, which then turns into a non-toxic, anti-microbial, odor-counteracting gel upon exposure to a liquid such as water, emitting a deodorizing and/or pleasant smell while moisture is being removed and absorbed from the atmosphere. Thus, if the container 50 is inadvertently knocked over, no water would be spilled therefrom. After all of the moisture-absorbing material has dissolved from the tray, and after all of the excess moisture has transformed the powder or the like into odor-counteracting gel, such gel may merely be discarded and replenished with a fresh gelling agent as desired.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A container for use with a moisture absorber comprising:
a. an upper half and a lower half that, when joined together, define an enclosed interior; and
b. a removable tray seated above a collection surface on said lower half for retaining a moisture absorbing medium, said removable tray having a plurality of openings that allow absorbed moisture to pass from the tray to the collection surface;
c. wherein said upper half further comprises a plurality of openings that allow air to pass from outside said container to the enclosed interior.

2. A container in accordance with claim 1, wherein the upper and lower halves are molded shells connected by a living hinge.

3. A container in accordance with claim 1, wherein said upper half further comprises a plurality of surfaces and said plurality of openings on said upper half are provided on more than one surface of said upper half.

4. A container in accordance with claim 1, wherein said tray is approximately half as deep as said lower half.

5. A container in accordance with claim 1, wherein said upper half is deeper than said tray.

6. A container in accordance with claim 1, further comprising ridges provided on said upper half that are aligned with at least some of said plurality of openings on said upper half.

7. A container in accordance with claim 1, further comprising a first mounting opening provided on a rear surface of said upper half for mounting said container on a wall.

8. A container in accordance with claim 7, further comprising a second mounting opening provided on a top surface of said upper half for hanging said container from a support.

9. A container in accordance with claim 8, further comprising a hanger that extends through said second mounting opening and is anchored to said container by said first mounting opening.

10. A container in accordance with claim 1, further comprising a hanger that extends through a top surface of said upper half and is anchored to said container by a surface other than said top surface of said container.

11. A container including a moisture absorber comprising:
a. a container having an upper half and a lower half that, when joined together, define an enclosed interior, said upper half further comprising a plurality of openings that allow air to pass from outside said container to the enclosed interior;
b. a removable tray seated above a collection surface on said lower half of the container; and
c. a moisture absorbing medium provided on said removable tray, the removable tray having a plurality of openings that allow moisture absorbed from the air to pass from the tray to the collection surface.

12. A container in accordance with claim 11, wherein the upper and lower halves are molded shells connected by a living hinge.

13. A container in accordance with claim 11, wherein said upper half is deeper than said tray.

14. A container in accordance with claim 11, wherein said moisture absorbing medium is dissolvable.

15. A container in accordance with claim 11, further comprising a hanger that extends through a top surface of said upper half and is anchored to said container by a surface other than said top surface of said container.

16. A container in accordance with claim 11, further comprising a deodorizing medium on said removable tray that emits a deodorizer through said plurality of openings in said upper half.

17. A container in accordance with claim 11, further comprising a deodorizing medium on said collection surface tray that emits a deodorizer through said plurality of openings in said upper half.

18. A container in accordance with claim 17, wherein said deodorizing medium is a non-toxic gelling agent.

19. A combination moisture absorber and deodorizer comprising:
a. a container having an upper half and a lower half that, when joined together, define an enclosed interior, said upper half further comprising a plurality of openings that allow air to pass from outside said container to the enclosed interior;
b. a tray seated above a collection surface on said lower half of the container;
c. a moisture absorbing medium provided on said tray, the tray having a plurality of openings that allow moisture absorbed from the air to pass from the tray to the collection surface; and
d. a deodorizing medium provided on said collection surface.

20. A container in accordance with claim 19, wherein said deodorizing medium is a non-toxic gelling agent.
